(19) United States
(12) Patent Application Publication
(10) Pub. No.: US 2011/0314615 A1
(43) Pub. Date: Dec. 29, 2011

(54) MULTI-FUNCTIONAL HAND TOOL

(76) Inventor: Yung-Shou Chen, Taichung Hsien (TW)

(21) Appl. No.: 12/822,149

(22) Filed: Jun. 23, 2010

(51) Int. Cl. B25F 1/00; B25C 11/00

(52) U.S. Cl. 7/151; 254/21

(57) ABSTRACT

A multi-functional hand tool includes a nail pulling hole formed at the front end of an extension portion of a handle of the hand tool and/or a bottle opening hole formed at the other end of the extension portion of the handle. The nail pulling hole may be in the form of water drop. Thus, the hand tool is provided with a single or dual additional function of pulling out nails and opening bottle caps.

### BACKGROUND OF THE INVENTION

(a) Field of the Invention

This invention relates to a hand tool and particularly to a multi-functional hand tool for pulling out nails and opening bottle caps in addition to its normal use.

(b) Description of the Prior Art

A conventional hand tool, such as a common hammer, is provided with a head formed with a sheep-horn-like portion having a V-shaped groove for pulling out nails. However, by means of only the sheep-horn portion, it is difficult for the tool to operate in various spaces or environments. For example, in a narrow operation space, the tool cannot be used to pull out nails with the sheep-horn portion, and thus lateral nail pulling is required. Further, while doing heavy work and thus sweating more than normal, the user often needs bottled drink for necessary water supply; however, often no bottle opener can be found nearby, which inevitably troubles the user.

Consequently, because of the technical defects described above, the applicant from his experience and research has developed the present invention, which can effectively eliminate the defects described above.

### SUMMARY OF THE INVENTION

This invention is mainly to provide a multi-functional hand tool having a nail pulling hole formed at the front end of an extension portion of a handle of the hand tool. The nail pulling hole may be in the form of a water drop so that the hole may be used for lateral nail pulling. Thus, the hand tool may still be used to pull out nails even in a narrow operation space or environment.

This invention further provides the multi-functional hand tool, with a bottle opening hole formed at the other end of extension portion of the handle of hand tool. Thus, when the user wants to drink bottle beverage, he or she may use the bottle opening hole provided in the hand tool to open the bottle cap.

### BRIEF DESCRIPTION OF THE DRAWINGS

FIG. 1 is a front view of the multi-functional hand tool according to this invention;

FIG. 2 is a top sectional view of the multi-functional hand tool according to this invention;

FIG. 3 is a schematic view illustrating that a nail is being pulled by the multi-functional hand tool according to this invention; and

FIG. 4 is a schematic view illustrating that a bottle cap is being opened by the multi-functional hand tool according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

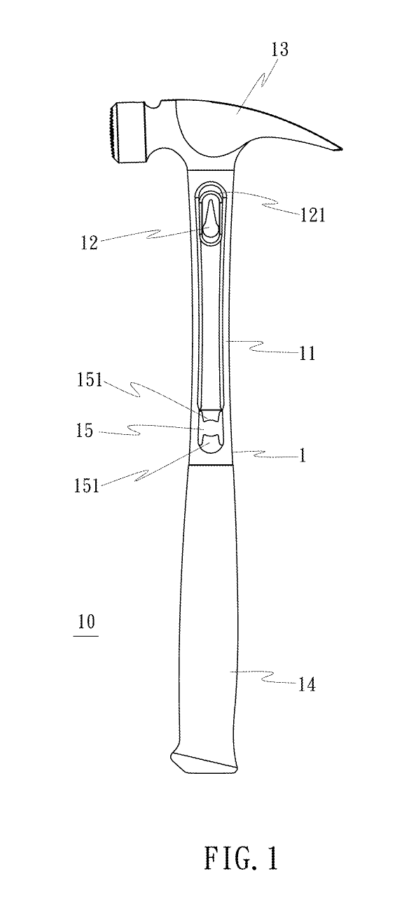

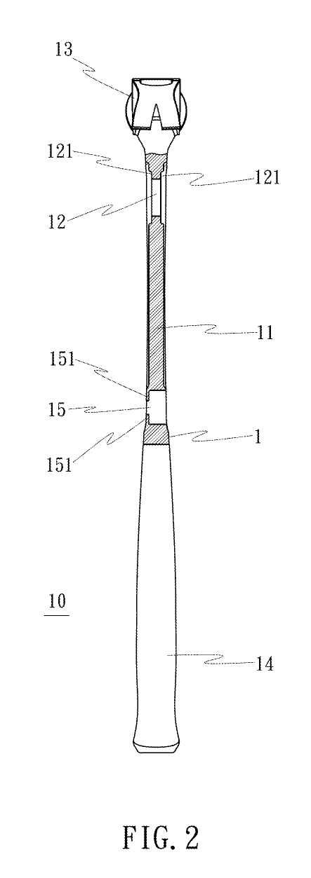

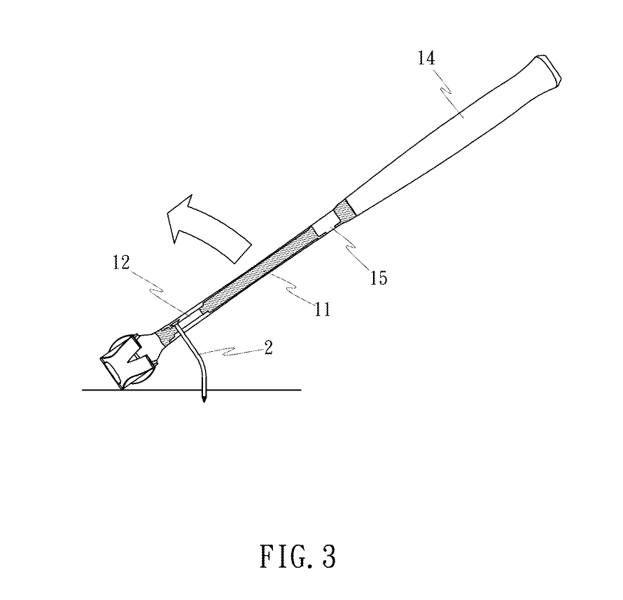

As shown in FIGS. 1 and 2, a multi-functional hand tool 10 according to this invention includes a nail pulling hole 12 formed mainly at the front end of an extension portion 11 of a metal handle 1 of the hand tool 10. As shown in the figures, the nail pulling hole may be in the form of a water drop, and the rod of the metal handle 1 is narrow and flat, as shown in FIG. 2. From the sectional view in FIG. 2, one side or two sides of the nail pulling hole 12 of the metal handle 1 are formed with recessed troughs 121. Thus, the nail 2 may be made to pass through the nail pulling hole 12 and then may wedge, as shown in FIG. 3, and further a tool body 13 at the head of the hand tool 10 is made to serve as a pivot to apply lateral nail pulling of the nail 2.

Similarly the nail pulling hole 12 coordinates with the two sides of rod that are formed with recessed troughs 121, so the nail 2 may surely pass through another side to complete the job of nail pulling. Thus, the hand tool in the narrow operation space or other special environments may be still used to pull out nails.

As shown in the figures, the tool body 13 in the embodiment described above is a hammerhead; however, the tool body may also be the head of an axe, a shovel, or another hand tool, if necessary. Further, regarding the metal handle 1, a colloidal knob sleeve 14 is generally put around the rear segment of the extension portion 11.

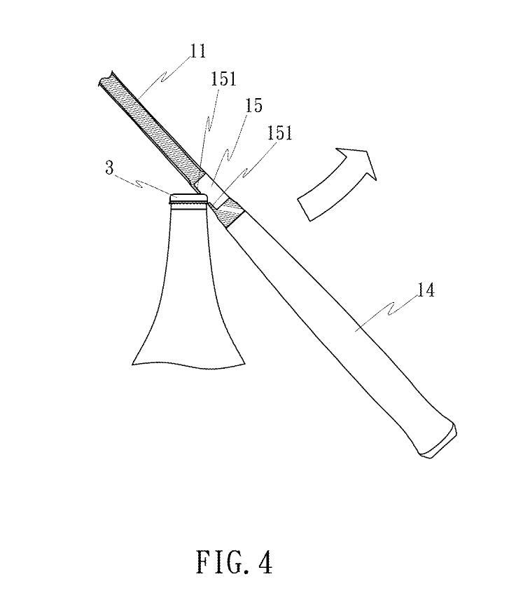

As shown in the embodiment of this invention shown in the figures, a bottle opening hole 15, as shown in a section in FIG. 2, may be formed at the other end of extension portion 11 of the metal handle 1 of the hand tool 10. The upper and lower sides of the wall of the bottle opening hole 15 may be formed with blocking tablets 151. Thus, the beverage bottle cap 3 may be wedged into the bottle opening hole 15, as shown in FIG. 4 and either blocking tablet 151 is used as the pivot to open the bottle cap 3. The bottle opening hole 15 is added to the metal handle 1 according to this invention, so when the user wants to drink bottle beverage, he or she may directly use the hand tool at all times to open the bottle cap without having to look for a bottle opener.

To sum up, the multi-functional hand tool according to this invention can be used for lateral nail pulling and for bottle cap opening, in addition to its normal use as a hammer, an axe, a shovel, etc.

While the invention has been described in terms of what is presently considered to be the most practical and preferred embodiments, it is to be understood that the invention needs not be limited to the disclosed embodiment. On the contrary, it is intended to cover various modifications and similar arrangements within the spirit and scope of the appended claims which are to be accorded with the broadest interpretation so as to encompass all such modifications and similar structures.

What is claimed is:

1. A multi-functional hand tool, comprising a handle with an extension portion and a nail pulling hole formed at a front end of the extension portion of the handle.

2. The multi-functional hand tool according to claim 1, wherein the nail pulling hole is in the form of a water drop.

3. The multi-functional hand tool according to claim 1, wherein recessed troughs are formed around one side or two sides of the nail pulling hole on the handle.

4. The multi-functional hand tool according to claim 1, wherein a bottle opening hole is formed at the other end of the extension portion of the handle.

5. The multi-functional hand tool according to claim 4, wherein two blocking tablets are formed respectively at an upper side and a lower side of the bottle opening hole.
